(19) United States
(12) Patent Application Publication
(10) Pub. No.: US 2007/0287807 A1
(43) Pub. Date: Dec. 13, 2007

(54) Heat-Activable, Pressure-Sensitive Adhesive Mass

(75) Inventors: Marc Husemann, Hamburg (DE); Stephan Zollner, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: tesa AG, Hamburg (DE)

(21) Appl. No.: 10/585,065

(22) PCT Filed: Dec. 7, 2004
(86) PCT No.: PCT/EP04/53309

§ 371 Date: Jul. 2, 2007

(30) Foreign Application Priority Data
Jan. 8, 2004 (DE) 10 2004 001 299.7

(51) Int. Cl. C09J 7/02; C08F 20/00

(52) U.S. Cl. 525/329.5

(57) ABSTRACT

The invention relates to a heat-activable pressure-sensitive adhesive. Provision is made for this heat-activable pressure-sensitive adhesive to comprise a polymer or copolymer formed from a monomer composition comprising at least 50% by weight of a compound of the formula CH₂═CH(R₁)(COOR₂), wherein R₁ represents H or CH₃ and R₂ represents H or an alkyl chain having 1 to 30 carbon atoms, the polymer or copolymer having a static glass transition temperature of −10° C. to 120° C.; a temperature activation range of 15° C. or less; and
a molecular weight distribution M_{w}/Mₙ of 2.5 or less.

The invention relates to a heat-activable pressure-sensitive adhesive, to a process for preparing it, and to a use of a heat-activable pressure-sensitive adhesive of this kind.

Heat-activable pressure-sensitive adhesives (heat-activable PSAs) are already well established and are frequently employed for industrial PSA tape applications. In general a distinction is made between adhesive tapes which already have a tack at room temperature and for which heat exposure raises the bond strength, and adhesive tapes which posses no tack at room temperature and only develop tack and bond strength at elevated temperatures. For heat-activable PSA tapes the adhesives used are very frequently polyacrylate or polymethacrylate adhesives. These polymers possess a variety of advantages over other elastomers. They are very stable toward UV light, oxygen, and ozone. Synthetic and natural rubber adhesives usually contain double bonds, which make these adhesives unstable toward the aforementioned environmental influences. A further advantage of polyacrylates is their transparency.

For the preparation of heat-activable PSAs there exists a variety of possibilities. U.S. Pat. No. 4,045,517 uses polymer blends of a polyacrylate having a low glass transition temperature and a polymer having a high glass transition temperature. The PSA tapes described therefore already possess a tack at room temperature.

JP 88056274-B uses mixtures of polyacrylates and nitrile rubber as heat-activable adhesives.

U.S. Pat. No. 4,199,646 describes heat-activable adhesive tapes composed of acrylate copolymers, including at least one comonomer which, following heat activation, by means of a functional group, reacts with a resin present in the mixture and therefore, by crosslinking, raises the heat resistance of the adhesive tape.

U.S. Pat. No. 4,545,843 uses heat-activable acrylate PSAs for porous substrates.

U.S. Pat. No. 4,880,683 describes polyacrylates which are heat-activable and become tacky at a temperature difference of 50° C. above the glass transition temperature.

U.S. Pat. No. 5,905,099 describes heat-activable acrylate and/or methacrylate PSAs which are used for reflective films.

All of the aforesaid heat-activable PSAs have the disadvantage of a relatively wide activation range; in other words, the adhesives become tacky within a range of more than 15° C. and therefore cannot be deployed precisely. One explanation of this is the polymerization process by which the polyacrylates have been prepared. In all cases the heat-activable polyacrylates or polymethacrylates are prepared via a free-radical addition polymerization, with the outcome that the polymers possess a broad molecular weight distribution. Since the glass transition temperature is a function of the polymer chain length, the activation temperature is scattered within a wide range of approximately 10° C.

It is an object of the invention to eliminate the disadvantages according to the prior art. The aim in particular is to specify a pressure-sensitive adhesive which exhibits a narrow activation range. Further objects are to specify a process for preparing a pressure-sensitive adhesive of this kind, and a use for a pressure-sensitive adhesive of this kind.

This object is achieved through the features of claims 1, 9, and 10. Advantageous embodiments of the inventions are apparent from the features of claims 2 to 8 and 11.

The invention provides a heat-activable pressure-sensitive adhesive which comprises a polymer or copolymer formed from the monomer composition which comprises at least 50% by weight of a compound of the formula CH₂═CH(R₁)(COOR₂), wherein R₁ represents H or CH₃ and R₂ represents H or an alkyl chain having 1 to 30 carbon atoms, the polymer or copolymer having

a static glass transition temperature of −10° C. to 120° C.;

a temperature activation range of 15° C. or less; and

a molecular weight distribution M_{w}/Mₙ of 2.5 or less.

The PSA of the invention can be obtained by controlled free-radical addition polymerization. By means of controlled free-radical addition polymerization it is therefore possible to obtain a PSA having a narrow molecular weight distribution and exhibiting a narrow activation range.

The compound embraced by the formula CH₂═CH(R₁)(COOR₂), wherein R₁ represents H or CH₃ and R₂ represents H or an alkyl chain having 1 to 30 carbon atoms, is therefore, if R₂ represents H, acrylic acid or methacrylic acid, and, if R₂ is not H, an acrylic ester or methacrylic ester.

M_{w} is the weight average of the molecular weight of the polymer or copolymer. Mₙ is the number average of the molecular weight of the polymer or copolymer.

The PSAs of the invention are heat-activable pressure-sensitive poly(meth)acrylate adhesives.

The heat-activable PSA of the invention is sometimes referred to below as pressure-sensitive adhesive or pressure-sensitive acrylate adhesive. Statements referring to the polymer apply equally to the copolymer, and vice versa, unless indicated otherwise. The polymer or copolymer is sometimes referred to below as poly(meth)acrylate.

The invention is described at greater length below, with reference to the drawings, of which

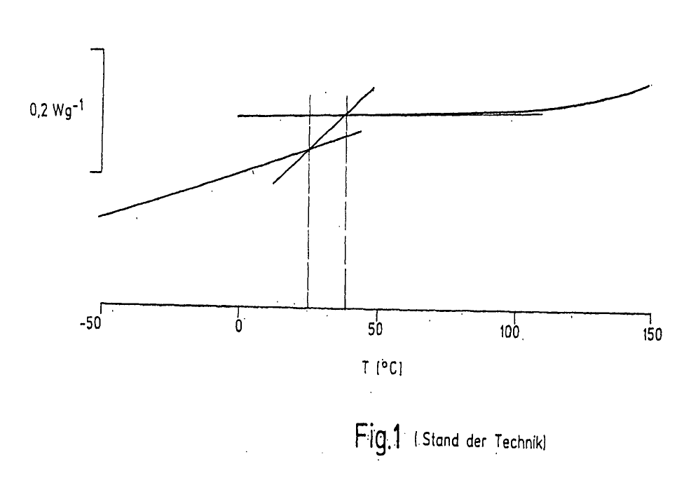

FIG. 1 is a DSC diagram for a first prior-art PSA;

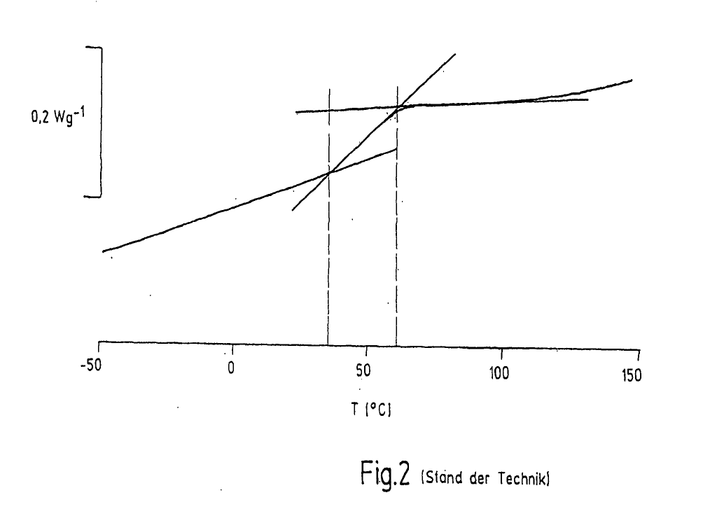

FIG. 2 is a DSC diagram for a second prior-art PSA;

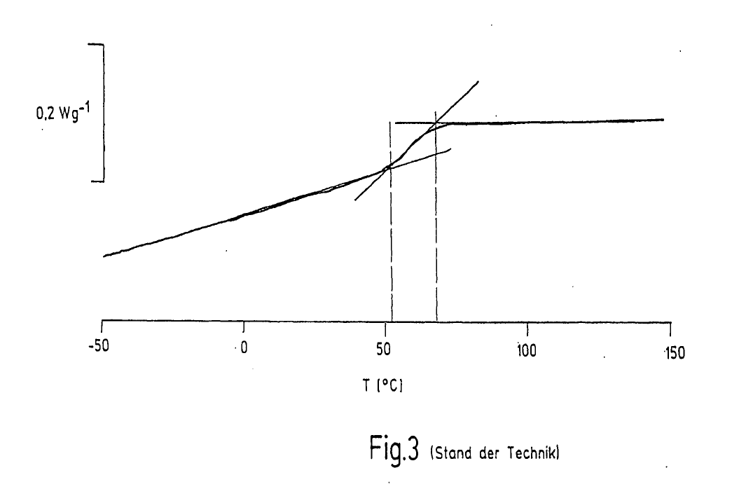

FIG. 3 is a DSC diagram for a third prior-art PSA;

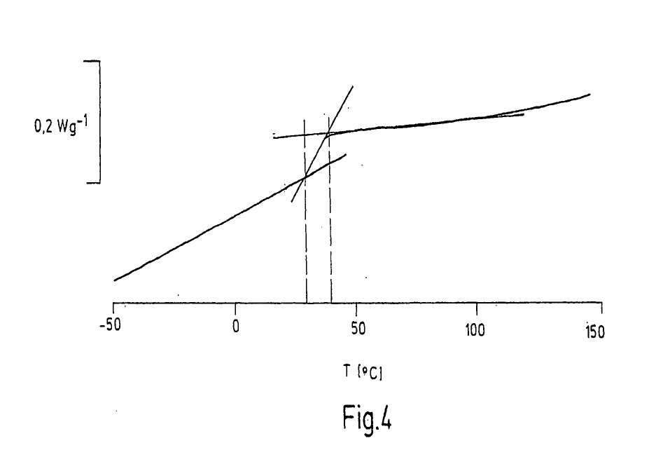

FIG. 4 is a DSC diagram for a first inventive, heat-activable PSA;

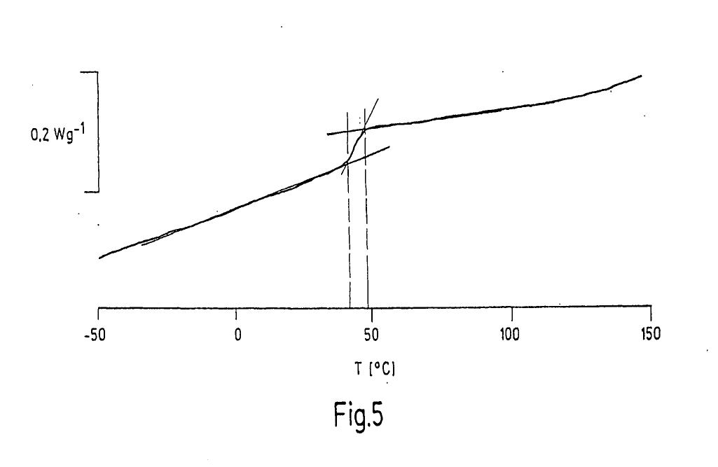

FIG. 5 is a DSC diagram for a second inventive, heat-activable PSA; and

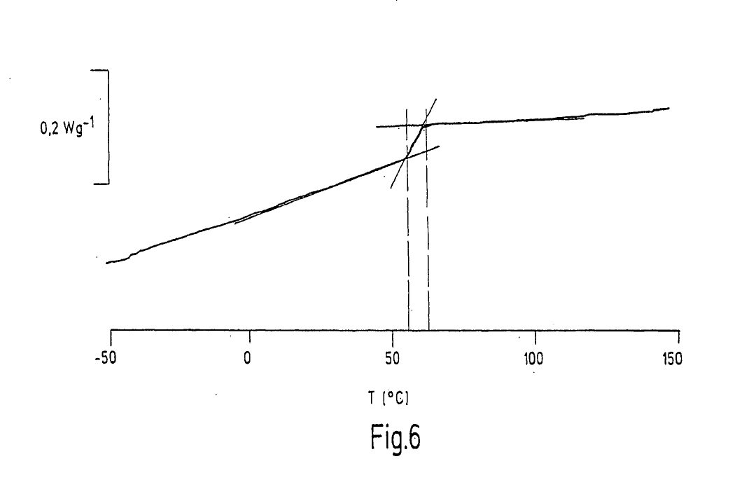

FIG. 6 is a DSC diagram for a third inventive, heat-activable PSA.

### HEAT-ACTIVABLE POLY(METH)ACRYLATES

The static glass transition temperature of a polymer is determined preferably by a method of Fox (Fox, T. G. Bull. Am. Phys. Soc. (Ser. 2) 1:123 (1956)).

In order to prepare a heat-activable PSA it is necessary to raise the static glass transition temperature as compared with conventional acrylate PSAs. This can be accomplished through the use of monomers which in homopolymer form possess a relatively high static glass transition temperature, or by altering the proportions of the comonomer composition.

In order to allow effective handling of the heat-activable PSA of the invention it is preferred to select a static glass transition temperature in a range from 0 to 100° C. At temperatures below 0° C. the tack and the bond strength become too great, and the PSA tape can no longer be effectively repositioned. For certain applications, nevertheless, it may be of advantage to use even adhesive tapes having a static glass transition temperature of −10° C. At static glass transition temperatures of more than 40° C. the bond strength at room temperature becomes extremely low, so that these adhesive tapes can no longer be reliably positioned. Within the industry, nevertheless, their exists a series of applications which do not require this function, so that even heat-activable PSAs having a static glass transition temperature of up to 120° C. are employed.

In a further preferred embodiment of the invention the monomer composition from which the copolymer of the heat-activable PSA of the invention is formed is as follows:

(a1) 10% to 85% by weight of an acrylate or methacrylate ester of a nontertiary alcohol, whose homopolymer has a static glass transition temperature of 0° C. or less;

(a2) 0 to 70% of an acrylate or methacrylate ester of an alcohol, whose homopolymer has a static glass transition temperature of at least 50° C.; and

(a3) 5% to 50% by weight of a monomer which carries a polar functional group.

In one very preferred embodiment acrylic or methacrylic monomers are used for (a1) and (a2) that are composed of acrylic and methacrylic esters having alkyl groups of 4 to 14 carbon atoms, preferably 4 to 9 carbon atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethylhexyl acrylate, 2-ethylhexyl methacrylate, isooctyl acrylate, and isooctyl methacrylate, for example.

Further classes of compound which can be used under (a2) are monofunctional acrylates and methacrylates of bridged cycloalkyl alcohols composed of at least 6 carbon atoms. The cycloalkyl alcohols may also be substituted, by C1-6 alkyl, halogen or cyano, for example. Specific examples are cyclohexyl methacrylates, isobornyl acrylate, isobornyl methacrylates, and 3,5-dimethyladamantyl acrylate.

For (a3) use is made in one preferred embodiment of monomers which carry a polar group such as carboxyl, sulfonic acid and phosphonic acid, hydroxyl, lactam and lactone, N-substituted amide, N-substituted amine, carbamate, epoxy, thiol, ether, alkoxy, cyano of the like.

Moderate basic monomers are, for example, N,N-dialkyl-substituted amides, such as N,N-dimethylacrylamide, N,N-dimethylmethylmethacrylamide, N-tert-butylacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylol-methacrylamide, N-(buthoxymethyl)methacrylamide, N-methylolacrylamide, N-(ethoxy-methyl)acrylamide, and N-isopropylacrylamide, this enumeration not being conclusive.

Further particularly preferred examples for (a3) are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, and dimethylacrylic acid, this enumeration not being conclusive.

In a further very preferred embodiment monomers (a3) used are vinyl esters, vinyl ethers, vinyl halides, vinylidene halides, and vinyl compounds with aromatic rings and heterocycles in α position. Here again mention may be made, nonexclusively, of some examples: vinyl acetate, vinylformamide, vinylpyridine, ethyl vinyl ether, vinyl chloride, vinylidene chloride, and acrylonitrile.

In a further preferred embodiment monomers possessing a high static glass transition temperature are added to the comonomers (a1) to (a3) described. Suitable components include aromatic vinyl compounds, such as styrene, the aromatic nuclei being composed preferably of C₄ to C₁₈ and being able also to include heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate and methacrylate, 2-naphthyl acrylate and methacrylate, and also mixtures of these monomers, this enumeration not being conclusive.

In general a rising proportion of a monomer which in homopolymer form possesses a high static glass transition temperature raises the static glass transition temperature of the polymer as a whole, and the tack and also the bond strength are reduced at room temperature. Through the selection of the proportions of monomers which in homopolymer form possess either a low or a high glass transition temperature it is possible to adjust the properties, i.e., the activation temperature.

For the polymerization process by controlled free-radical addition polymerization it is preferred to use a control reagent of the general formula: 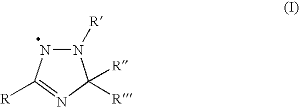
in which
R, R′, R″, R′″ are chosen independently of one another or are the same and represent
   branched and unbranched C₁- to C₁₈ alkyl radicals; C₃- to C₁₈ alkenyl radicals; C₃- to C₁₈ alkynyl radicals;
   H or C₁- to C₁₈ alkoxy;
   C₃- to C₁₈ alkenyl radicals; C₃- to C₁₈ alkynyl radicals; C₁- to C₁₈ alkyl radicals, substituted by at least one OH group or a halogen atom or a silyl ether;
   C₂-C₁₈ hetero-alkyl radicals having at least one oxygen atom and/or one NR′ group in the carbon chain;
   C₃-C₁₈ alkenyl radicals, C₃-C₁₈ alkynyl radicals, C₁-C₁₈ alkyl radicals, substituted by at least one ester group, amino group, carbonate group. cyano, isocyano and/or epoxide group and/or by sulfur;
   C₃-C₁₂ cycloalkyl radicals;
   C₆-C₁₀ aryl radicals; or
   hydrogen;
      or
R″ and R′″ are joined to one another in the form of spirol compounds.

Control reagents of the formula (I) are composed in one more-preferred embodiment of the following, further-restricted compounds:

Halogens here are preferably F, Cl, Br or I, more preferably Cl and Br. Outstandingly suitable alkyl, alkenyl, and alkynyl radicals in the various substituents include not only linear but also branched chains.

Examples of alkyl radicals containing 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl.

Examples of alkenyl radicals of 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.

Examples of alkynyl of 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl or hydroxyhexyl.

Examples of halogen-substituted alkyl radicals are dichlorobutyl, monobromobutyl or trichlorohexyl.

An example of a suitable C₂-C₁₈-heteroalkyl radical having at least one oxygen atom in the carbon chain is —CH₂—CH₂—O—CH₂—CH₃.

Examples of C₃-C₁₂ cycloalkyl radicals include cyclopropyl, cyclopentyl, cyclohexyl or trimethylcyclohexyl.

Examples of C₆-C₁₀ aryl radicals include phenyl, naphthyl, benzyl or further-substituted phenyl, such as ethyl, toluene, xylene, mesitylene, isopropylbenzene, dichlorobenzene or bromotoluene, for example.

The lists above serve only as examples of the respective groups of compound, and make no claim to completeness.

In one particularly preferred embodiment of the invention compounds of the formula (Ia) and (Ib) are used as control reagents.

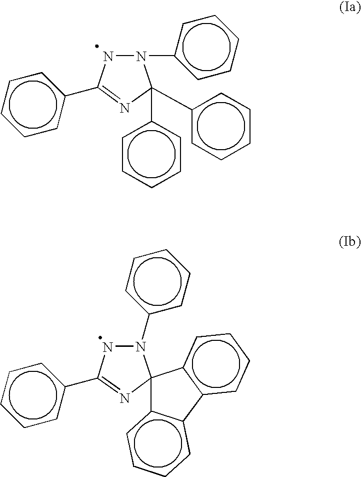

As further controlled free-radical polymerization methods it is possible to employ ATRP, RAFT or nitroxide/tempo-controlled reactions. For the purpose of free-radical stabilization use is made of nitroxides of the formula (IIa) or (IIb): 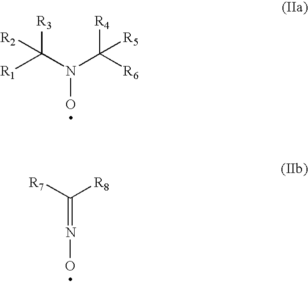
where R₁, R₂, R₃, R₄, R₅, R₆, R₇, and R₈ independently of one another denote the following compounds or atoms:
i) halides, such as chlorine, bromine or iodine, for example;
ii) linear, branched, cyclic, and heterocyclic hydrocarbons of 1-20 carbon atoms, which may be saturated, unsaturated, and aromatic;
iii) esters —COOR₉, alkoxides —OR₁₀ and/or phosphonates —PO(OR₁₁)₂, where R₉, R₁₀ or R₁₁ are radicals from group ii).

The compounds of the formula (IIa) or (IIb) can also be attached to polymer chains of any kind and may therefore be utilized for the molecular enlargement of the copolymers, as macroradicals or macroregulators.

As controlled regulators for the polymerization it is additionally possible to use the following compounds:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-ROXYL, 3-methoxy-PROXYL, 3-tert-butyl-PROXYL, 3,4-di-tert-butyl-PROXYL
2,2,6,6-tetramethyl-1-piperidinyloxypyrrolidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-tert-butyl nitroxide
diphenyl nitroxide
tert-butyl tert-amyl nitroxide

As a further variant it is possible to carry out the RAFT process (reversible addition-fragmentation chain transfer). The process is described at length in patents WO 9801478 and WO 9931144.

In very preferred embodiments polymerization processes are carried out of the kind described in DE 100 36 801.8 and DE 100 30 217.3.

In conjunction with the abovementioned polymerizations which proceed by a controlled-growth free-radical mechanism it is preferred to use initiator systems which additionally contain further free-radical initiators for the polymerization, especially radical-forming azo or peroxo initiators which undergo thermal decomposition. It is possible in principle for this purpose, however, to employ all typical initiators that are known for acrylates and methacrylates, respectively. The production of C-centered radicals is described in Houben-Weyl, Methoden der Organischen Chemie, Vol. E 19a, pp. 60-147. These methods are preferentially employed in analogy.

Examples of radical sources are peroxides, hydroperoxides, and azo compounds. Some examples of typical free-radical initiators that may be mentioned here include the following: potassium peroxodisulfate, dibenzoyl peroxide, cumene hydroperoxide, cyclohexanone peroxide, di-tert-butyl peroxide, azodiisobutyronitrile, cyclohexylsulfonyl acetyl peroxide, diisopropyl percarbonate, tert-butyl peroctoate, and benzpinacole, this enumeration not being conclusive. In one very preferred embodiment a free-radical initiator used is 1,1′-azobis(cyclohexanecarbonitrile) (Vazo 88™ from DuPont).

In addition it is also possible to use radical sources which release free radicals only under UV light exposure.

Another controlled polymerization method which can be used is that of Atom Transfer Radical Polymerization (ATRP), with the use being made as initiator preferably of monofunctional or difunctional, secondary or tertiary halides and, to abstract the halide(s), complexes of Cu, Ni, Fe, Pd, Pt, Ru, Os, Rh, Co, Ir, Cu, Ag or Au [EP 0 824 111; EP 0 826 698; EP 0 824 110: EP 0 841 346; EP 0 850 957]. The different possibilities of ATRP are further described in patents U.S. Pat. No. 5,945,491, U.S. Pat. No. 5,854,364, and U.S. Pat. No. 5,789,487.

The average molecular weights M_{w} (weight averages) of the PSAs formed in the controlled free-radical addition polymerization are chosen such as to lie within a range from 50 000 and 1 500 000; specifically for further use as heat-activable adhesive tapes, PSAs are prepared that have an average molecular weight of 200 000 to 1 000 000. The average molecular weight is determined by way of gel permeation chromatography (GPC) or matrix-assisted laser desorption/ionization coupled with mass spectrometry (MALDI-MS).

The polymerization may be conducted in the presence of an organic solvent, in the presence of water, or in mixtures of organic solvents and water. The aim here is to minimize the amount of solvent used. Suitable organic solvents or mixtures of solvents are pure alkanes (hexane, heptane, octane, isooctane), aromatic hydrocarbons (benzene, toluene, xylene), esters (ethyl acetate, propyl, butyl or hexyl acetate), halogenated hydrocarbons (chlorobenzene), alkanols (methanol, ethanol, ethylene glycol, ethylene glycol monomethyl ether), and ethers (diethyl ether, dibutyl ether) or mixtures thereof. The aqueous polymerization reactions can be admixed with a water-miscible or hydrophilic cosolvent in order to ensure that during monomer conversion the reaction mixture is present in the form of a homogeneous phase. Cosolvents which can be used with advantage for the present invention are selected from the group consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones, and the like, and also derivatives and mixtures thereof.

Depending on conversion and temperature, the polymerization time amounts to between 4 and 48 hours. The higher the reaction time that can be chosen, in other words the higher the thermal stability of the reaction mixture, the lower the level at which the reaction time can be chosen.

As regards initiation of the polymerization, the introduction of heat is essential for the thermally decomposing initiators. For these initiators the polymerization can be initiated by heating at 50 to 160° C., depending on initiator type. For the use of UV initiators, irradiation is carried out using UV light of the appropriate wavelength. This reaction can be carried out in a temperature range from 0° C. to 150° C.

When the step of polymerization is at an end the reaction mixture can be cooled to a temperature below 60° C., preferably to room temperature.

For the adhesive bonding properties it can be of advantage to crosslink the heat-activable adhesive. For UV crosslinking it is preferred in that case to add UV photoinitiators. The photoinitiators may be of the Norrish I or Norrish II type. Certain groups of photoinitiators may be listed, as follows: benzophenones, acetophenones, benzils, benzoins, hydroxy-alkylphenones, phenyl cyclohexyl ketones, anthraquinones, trimethylbenzoylphosphine oxides, methylthiophenyl morpholine ketones, amino ketones, azo benzoins, thioxanthones, hexarylbisimidazoles, triazines or fluorenone, it being possible for each of these radicals to be additionally substituted by one or more halogen atoms and/or one or more alkoxy groups and/or one or more amino groups or hydroxyl groups. A representative overview is given in “Photoinitiation Photopolymerization and Photocuring, Fundamentals and Applications, by J.-P. Fouassier, Hanser Publishers, Munich, Vienna, New York 1995”. For further details reference may be made to “Chemistry & Technology of UV & EB formulation for Coatings, Inks & Paints, Volume 5, A. Carroy, C. Decker. J. P. Dowling, P. Pappas, B. Monroe, ed. By P. K. T. Oldring, publ. By SITA Technology, London, England 1994”.

Where the heat-activable PSA is applied from solution it can be of advantage for it to contain 0.05% to 3% by weight, more preferably 0.1% to 2% by weight, of crosslinker, based on the weight fraction of the monomers of the adhesive.

The crosslinker is typically a metal chelate or an organic compound that reacts with a functional group of a comonomer and so reacts directly with the polymer. Also suitable for thermal crosslinking, moreover, are peroxides. For polymers containing acid groups it is also possible to employ polyfunctional isocyanates and epoxides.

For the use of the poly(meth)acrylates prepared by the process of the invention as heat-activable PSAs, the polymers are optimized by optional blending with at least one resin. As tackifying resins for addition it is possible without exception to use all existing tackifier resins described in the literature. Representatives that may be mentioned include pinene resins, indene resin, and rosins, their disproportionated, hydrogenated, polymerized, and esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resultant PSA in accordance with requirements. Generally speaking it is possible to use any resins which are compatible with the polyacrylate in question (i.e., are soluble), reference may be made in particular to all aliphatic, aromatic, and alkylaromatic hydrocarbon resins, hydrocarbon resins based on single monomers, hydrogenated hydrocarbon resins, functional hydrocarbon resins, and natural resins. Express reference may be made to the depiction of the state of the art in the “Handbook of Pressure Sensitive Adhesive Technology” by Donatas Satas (van Nostrand, 1989).

In a further advantageous onward development the PSA is admixed with one or more plasticizers, such as low molecular mass polyacrylates, phthalates, amine-based polar plasticizers, or plasticizer resins.

The acrylate PSAs may further be blended with one or more additives such as aging inhibitors, light stabilizers, ozone protectants, fatty acids, resins, nucleators, expandants, compounding agents and/or accelerants.

Additionally they may be admixed with one or more fillers such as fibers, carbon black, zinc oxide, titanium dioxide, solid or hollow glass (micro)spheres, microspheres of other materials, silica, silicates, and chalk, the addition of blocking-free isocyanates being a further possibility.

Particularly for use as a pressure-sensitive adhesive it is advantageous for the process of the invention if the polyacrylate is applied preferably from the melt, as a layer, to a carrier or to a carrier material.

For this purpose the heat-activable poly(meth)acrylates prepared as described in the text above are concentrated to a hotmelt whose solvent content is ≦2% by weight, more preferably one having a solvent content ≦0.5% by weight. This operation preferably takes place in a concentrating extruder. The adhesive is then applied, in one preferable variant of the process, as a hot-melt composition, in the form of a layer, to a carrier or to a carrier material.

Carrier materials used for the PSA, for adhesive tapes for example, are the typical materials familiar to the skilled worker, such as films (polyester, PET, FE, PP, BOPP, PVC), nonwovens, foams, woven fabrics, and woven films, and also release paper (glassine, HDPE, LDPE). This enumeration is not conclusive.

For the PSA utility it is particularly advantageous to crosslink the polyacrylates after they have been coated onto the carrier or carrier material. To produce the PSA tapes the polymers described above are optionally blended for this purpose with crosslinkers. Preferred radiation-crosslinking substances in accordance with the process of the invention are, for example, difunctional or polyfunctional acrylates or difunctional or polyfunctional urethane acrylates, difunctional or polyfunctional isocyanates or difunctional or polyfunctional epoxides. Similar examples of these are 1,6-hexanediol diacrylate, pentaerythritol tetraacrylate, trimethylolpropane triacrylate or ethylene 1,2-glycol diacrylate. Use may also be made here, however, of all further difunctional or polyfunctional compounds familiar to the skilled worker and capable of crosslinking polyacrylates.

If the heat-activable PSA is to be UV-crosslinked then this takes place by means of ultraviolet irradiation in a wavelength range from 200 to 450 nm, in particular using high-pressure or medium-pressure mercury lamps with an output of 80 to 240 W/cm. For the purpose of UV crosslinking, however, it is also possible to use monochromatic radiation in the form of lasers. In order to prevent overheating it may be appropriate to shade off part of the UV beam path. A further possibility is to use special reflector systems which function as cold light emitters, in order thus to prevent instances of overheating.

Although not advantageous for the process of the invention, it may be appropriate also to crosslink the heat-activable polymers of the invention using electron beams. Typical irradiation equipment which could be employed is represented by linear cathode systems, scanner systems, or segmented cathode systems, in the case of electron beam accelerators. An exhaustive description of the state of the art and of the most important process parameters is found in Skelhorne “Electron Beam Processing” in Vol. 1 “Chemistry & Technology of UV & EB Formulations for Coatings, Inks & Paints” publ. Sita Technology, London 1991. The typical acceleration voltages are situated in the range between 50 kV and 500 kV, preferably 80 kV to 300 kV. The radiation doses employed range between 5 to 150 kGy, in particular 20 to 100 kGy.

Additionally claimed is the use of the poly(meth)acrylate prepared by the process of the invention as a heat-activable pressure-sensitive adhesive.

Of particular advantage is the use of the pressure-sensitive adhesive of the invention for an adhesive tape, in which case the pressure-sensitive adhesive may be applied on one or both sides of a carrier.

### EXAMPLES

Test Methods

The following test methods were employed in order to evaluate the properties, particularly the adhesive bonding properties, of the heat-activable PSAs prepared.

180° Bond Strength Test (Test A)

A strip 20 mm wide of an adhesive tape composed of a heat-activable (meth)acrylate adhesive applied as a layer to polyester (50 g/m²) was applied to steel plates. The strip was pressed onto the substrate twice using a 2 kg weight. The adhesive tape was then immediately peeled from the substrate at 300 mm/min and at an angle of 180°. The steel plates were washed twice with acetone and once with isopropanol. The results of the measurements are recorded in N/cm and are averaged from three measurements. All the measurements were carried out at room temperature under standardized conditions (23° C. and 50% humidity).

180° Bond Strength Test after Heat Activation (Test B)

Test A was repeated but with the bond being made on a heatable bond strength rail, the measurement temperature selected here being a temperature of 35° C. To carry out the application, the measurement strip was preheated to 35° C. in a drying cabinet beforehand.

Differential Scanning Calorimetry (DSC) (Test C)

The DSC measurements were carried out using the Mettler DSC 30 instrument from Mettler. Approximately 10 mg of sample were weighed out for measurement. The heating rate was 10 K per minute. Measurement is made under a nitrogen atmosphere. Two heating curves were recorded in succession, with only the second curve being evaluated.

Gel Permeation Chromatography GPC (Test D)

The average molecular weight M_{w} and the polydispersity PD were determined by the company Polymer Standards Service, Mainz, Del. The eluent used was THF containing 0.1% by volume trifluoroacetic acid. Measurement took place at 25° C. The precolumn used was PSS-SDV, 5μ, 10³ Å, ID 8.0 mm×50 mm. Separation was carried out using the columns PSS-SDV, 5μ, 10³ and also 10⁵ and 10⁶ each with ID 8.0 mm×300 mm. The sample concentration was 4 g/l, the flow rate 1.0 ml per minute. Measurement was made against PMMA standards.

### Preparation of bis-2,2′-phenylethyl thiocarbonate

Bis-2,2′-phenylethyl thiocarbonate is synthesized starting from 2-phenylethyl bromide with carbon disulfide and sodium hydroxide in accordance with a procedure from Synth. Communications 18(13), pp. 1531-1536, 1988. Yield after distillation: 72%.

¹H NMR (CDCl₃) δ (ppm): 7.20-7.40 (m, 10H), 1.53, 1.59 (2×d, 6H), 3.71, 381 (2×m, 2H).

Polymerizations

### Comparative Example R1

A 2 L glass reactor conventional for free-radical addition polymerization was charged with 20 g of acrylic acid, 180 g of butyl acrylate, 100 g of tert-butyl acrylate, 100 g of methyl methacrylate, and 170 g of acetone. After nitrogen gas had been passed through the reactor for 45 minutes with stirring the reactor was heated to 58° C. and 0.2 g of azoisobutyronitrile (AIBN, Vazo 64™, DuPont) was added. Subsequently the external heating bath was heated to 75° C. and the reaction was carried out constantly at this external temperature. After a reaction time of 1 hour a further 0.2 g of AIBN was added. After 4 hours dilution took place with 100 g of acetone. To reduce the level of residual initiators, 1 g portions of bis(4-tert-butylcyclohexanyl) peroxydicarbonate (Perkadox 16™, Akzo Nobel) were added after 5 hours and after 7 hours respectively. The reaction was terminated after a time of 24 hours and the batch cooled to room temperature. The polymer was analyzed by test D. The DSC diagram of the polymer is shown in FIG. 1.

### Comparative Example R2

A 2 L glass reactor conventional for free-radical addition polymerization was charged with 200 g of 2-ethylhexyl, 80 g of N,N-dimethylacrylamide, 120 g of methyl methacrylate, and 120 g of acetone. After nitrogen gas had been passed through the reactor for 45 minutes with stirring the reactor was heated to 58° C. and 0.2 g of azoisobutyronitrile (AIBN, Vazo 64™, DuPont) was added. Subsequently the external heating bath was heated to 75° C. and the reaction was carried out constantly at this external temperature. After a reaction time of 1 hour a further 0.2 g of AIBN was added. After 4 hours dilution took place with 100 g of acetone. To reduce the level of residual initiators, 1 g portions of bis(4-tert-butylcyclohexanyl) peroxydicarbonate (Perkadox 16™, Akzo Nobel) were added after 5 hours and after 7 hours respectively. The reaction was terminated after a time of 24 hours and the batch cooled to room temperature. The polymer was analyzed by test D. The DSC diagram of the polymer is shown in FIG. 2.

### Comparative Example R3

A 2 L glass reactor conventional for free-radical addition polymerization was charged with 36 g of acrylic acid, 124 g of butyl acrylate, 120 g of tert-butyl acrylate, 120 g of methyl methacrylate, and 170 g of acetone. After nitrogen gas had been passed through the reactor for 45 minutes with stirring the reactor was heated to 58° C. and 0.2 g of azoisobutyronitrile (AIBN, Vazo 64™, DuPont) was added. Subsequently the external heating bath was heated to 75° C. and the reaction was carried out constantly at this external temperature. After a reaction time of 1 hour a further 0.2 g of AIBN was added. After 4 hours dilution took place with 100 g of acetone. To reduce the level of residual initiators, 1 g portions of bis(4-tert-butylcyclohexanyl) peroxydicarbonate (Perkadox 16™, Akzo Nobel) were added after 5 hours and after 7 hours respectively. The reaction was terminated after a time of 24 hours and the batch cooled to room temperature. The polymer was analyzed by test D. The DSC diagram of the polymer is shown in FIG. 3.

### Example 1

A 2 L glass reactor conventional for free-radical addition polymerization was charged with 20 g of acrylic acid, 180 g of butyl acrylate, 100 g of tert-butyl acrylate, 100 g of methyl methacrylate, 0.2 g of bis-2,2′-phenylethyl thiocarbonate, and 40 g of ethyl acetate. After nitrogen gas had been passed through the reactor for 45 minutes with stirring the reactor was heated to 58° C. and 0.15 g of azoisobutyronitrile (AIBN, Vazo 64™, DuPont) was added. Subsequently the external heating bath was heated to 80° C. and the reaction was carried out constantly at this external temperature. After 8 hours dilution took place with 100 g of ethyl acetate. After a reaction time of 24 hours a further 0.15 g of AIBN was added. After 36 hours dilution took place with 100 g of ethyl acetate. The reaction was terminated after a time of 48 hours and the batch cooled to room temperature. The polymer was analyzed by test D. The DSC diagram of the polymer is shown in FIG. 4.

### Example 2

A 2 L glass reactor conventional for free-radical addition polymerization was charged with 200 g of 2-ethylhexyl acrylate, 80 g of N,N-dimethylacrylamide, 120 g of methyl methacrylate, 0.2 g of bis-2,2′-phenylethyl thiocarbonate, and 50 g of ethyl acetate. After nitrogen gas had been passed through the reactor for 45 minutes with stirring the reactor was heated to 58° C. and 0.15 g of azoisobutyronitrile (AIBN, Vazo 64™, DuPont) was added. Subsequently the external heating bath was heated to 80° C. and the reaction was carried out constantly at this external temperature. After 8 hours dilution took place with 100 g of ethyl acetate. After a reaction time of 24 hours a further 0.15 g of AIBN was added. After 36 hours dilution took place with 100 g of ethyl acetate. The reaction was terminated after a time of 48 hours and the batch cooled to room temperature. The polymer was analyzed by test D. The DSC diagram of the polymer is shown in FIG. 5.

### Example 3

A 2 L glass reactor conventional for free-radical addition polymerization was charged with 36 g of acrylic acid, 124 g of butyl acrylate, 120 g of tert-butyl acrylate, 120 g of methyl methacrylate, 0.2 g of bis-2,2′-phenylethyl thiocarbonate, and 40 g of ethyl acetate. After nitrogen gas had been passed through the reactor for 45 minutes with stirring the reactor was heated to 58° C. and 0.15 g of azoisobutyronitrile (AIBN, Vazo 64™, DuPont) was added. Subsequently the external heating bath was heated to 80° C. and the reaction was carried out constantly at this external temperature. After 8 hours dilution took place with 100 g of ethyl acetate. After a reaction time of 24 hours a further 0.15 g of AIBN was added. After 36 hours dilution took place with 100 g of ethyl acetate. The reaction was terminated after a time of 48 hours and the batch cooled to room temperature. The polymer was analyzed by test D. The DSC diagram of the polymer is shown in FIG. 6.

Results

The comparative examples, examples R1 to R3, were prepared as reference specimens. The comparative examples were prepared conventionally by free-radical addition polymerization. In comparison thereto, polymers 1, 2, and 3 were prepared via a controlled free-radical addition polymerization. All of the polymers were analyzed by test C. The results are reported in table 1 below:

TABLE 1

| Example | M_{w} [g/mol] | Polydispersity PD |
|---|---|---|
| R1 | 691 000 | 4.5 |
| R2 | 723 000 | 4.7 |
| R3 | 693 000 | 4.8 |
| 1 | 386 000 | 2.2 |
| 2 | 398 000 | 2.0 |
| 3 | 365 000 | 1.9 |

M_{w}: average molecular weight from GPC
PD: M_{w}/Mₙ = polydispersity from GPC

From table 1 it is apparent that the free-radical addition polymerizations carried out in controlled fashion provide a significantly narrower molecular weight distribution (PD). The polydispersities of the comparative examples are situated, generally, at a significantly higher level.

Below, the glass transition temperatures of the individual examples have been determined by means of DSC. The glass transition temperature indicates the temperature at which certain polymer chain segments begin to move, and the PSA becomes tacky. In order, then, to attain a very narrow switching temperature for a heat-activable PSA tape, the glass transition temperature range ought to be as narrow as possible. This range is determined from the values measured by DSC, with compensating lines being placed through the rising curve before and after the glass transition temperature. By placing a third line on the glass transition temperature, two points of interception are produced, which correlate one with the beginning of softening and the other with the end of the glass transition temperature range. Before the starting point and after the end point there is no longer any change in the properties of the polymer. The individual DSC diagrams of comparative examples R1 to R3 and of examples 1 to 3 are depicted in FIGS. 1 to 6. The respective glass transition temperatures and the start and end points are summarized in table 2 below.

TABLE 2

| | | Glass transition | | | |
|---|---|---|---|---|---|
| Example | DSC | temperature T_{g} | Tₛₜₐᵣₜ, [° C.] | T_{end} [° C.] | ΔT |
| R1 | | 34.2° C. | 25.8 | 42.6 | 16.8 |
| R2 | | 49.3° C. | 36.5 | 62.0 | 25.5 |
| R3 | | 60.8° C. | 52.6 | 69.0 | 16.4 |
| 1 | | 35.5° C. | 30.7 | 40.2 | 9.5 |
| 2 | | 45.6° C. | 542.5 | 48.6 | 6.1 |
| 3 | | 60.6° C. | 57.1 | 64.0 | 6.9 |

Table 2 shows that the comparative examples R1 to R3 exhibit a significantly greater temperature activation range. The values found all show a ΔT of more than 15° C. The narrow-distribution heat-activable PSAs, in contrast, exhibit a temperature activation range ΔT of in some cases much less than 15° C. (examples 1 to 3). From table 2 it can also be inferred that, through the choice and composition of the comonomers, it is possible to control the glass transition temperature and hence also the activation temperature.

The relatively narrow activation range has great advantages for industrial applications or in the medical sector, particularly when bonding temperature-sensitive substances which have a maximum temperature to which they can be exposed. In the biological sector in particular, for numerous bonds associated with the human skin, there are natural limits which exist, as a result of the body temperature. Hence for repositionability at room temperature an adhesive bond ought to have only a very low bond strength and, after heating, the maximum bond strength ought to be attained as rapidly as possible.

In the context of this application the bond strength at 23° C. and 35° C. was measured for comparative example R1 and for example 1. The results are summarized in table 3.

TABLE 3

| | BS-steel, 35° C. | BS-steel, 23° C. |
|---|---|---|
| Example | [N/cm] | [N/cm] |
| R1 | 3.3 | 0.6 |
| 1 | 3.4 | 0.2 |

BS: bond strength
50 g/m² coat weight

From table 3 it is apparent that the comparative example R1 has a significantly higher bond strength even under standard conditions (23° C., 50% humidity). The lower bond strength of example 1 allows this PSA to be repositioned significantly more effectively. In contrast, if example 1 or comparative example 1 is heated, they both possess approximately the same bond strength at higher temperatures (35° C.). The difference in the bonding performance is a consequence of the narrower activation range.

Besides the medical application already described there are a range of bonds in the industrial sector as well that require effective repositionability at room temperature and an increased bond strength under operating conditions. These applications are in many cases non-permanent bonds, i.e., the bond is undone again at the end of the operation. In the majority of cases the desire is for a very low application of force to be required to undo the bond. This is likewise a very preferred application for the heat-activable pressure-sensitive adhesives of the invention.

1. A heat-activable pressure-sensitive adhesive comprising a polymer or copolymer formed from a monomer composition comprising at least 50% by weight of a compound of the formula CH₂═CH(R₁)(COOR₂), wherein R₁ represents H or CH₃ and R₂ represents H or an alkyl chain having 1 to 30 carbon atoms, the polymer or copolymer having
a static glass transition temperature of −10° C. to 120° C.;
a temperature activation range of 15° C. or less; and
a molecular weight distribution M_{w}/Mₙ of 2.5 or less.

2. The heat-activable pressure-sensitive adhesive of claim 1, wherein the monomer composition comprises
(a1) 10% to 85% by weight of an acrylate or methacrylate ester of a nontertiary alcohol, whose homopolymer has a static glass transition temperature of 0° C. or less;
(a2) 0 to 70% of an acrylate or methacrylate ester of an alcohol, whose homopolymer has a static glass transition temperature of at least 50° C.; and
(a3) 5% to 50% by weight of a monomer which carries a polar functional group.

3. The heat-activable pressure-sensitive adhesive of claim 2, wherein components (a1) and (a2) are selected from the group consisting of acrylic and methacrylic esters each having alkyl groups of 4 to 9 carbon atoms.

4. The heat-activable pressure-sensitive adhesive of claim 2 wherein components (a1) and (a2) are selected independently of one another from the group consisting of methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof.

5. The heat-activable pressure-sensitive adhesive of claim 2, wherein component (a2) is selected from the group consisting of monofunctional acrylates and methacrylates of bridged substituted or unsubstituted cycloalkyl alcohols having at least 6 carbon atoms.

6. The heat-activable pressure-sensitive adhesive of claim 2, wherein component (a2) is selected from the group consisting of cyclohexyl methacrylates, isobornyl acrylate, isobornyl methacrylates, and 3,5-dimethyladamantyl acrylate.

7. The heat-activable pressure-sensitive adhesive of claim 2, wherein the polar group of component (a3) is a carboxyl, sulfonic acid, phosphonic acid, hydroxyl, lactam, lactone, N-substituted amide, N-substituted amine, carbamate, epoxy, thiol, ether, alkoxy or cyano group.

8. The heat-activable pressure-sensitive adhesive of claim 1, wherein the polymer or copolymer has a static glass transition temperature of 0° C. to 100° C.

9. A process for preparing the heat-activable pressure-sensitive adhesive of claim 1, wherein said monomer composition is polymerized by controlled free-radical addition polymerization.

10. An adhesive tape comprising the heat activable pressure-sensitive adhesive of claim 1.

11. The adhesive tape of claim 10, wherein the heat activable pressure-sensitive adhesive is coated onto one or both sides of a carrier.
